(19) United States
(12) Patent Application Publication
(10) Pub. No.: US 2020/0310722 A1
(43) Pub. Date: Oct. 1, 2020

(54) Printing using Multiple Printing Devices

(71) Applicant: KYOCERA Document Solutions Inc., Osaka (JP)

(72) Inventors: Sam Chinh Co Tang Chan, Garden Grove, CA (US); Duc Phu Truong, Westminster, CA (US)

(21) Appl. No.: 16/369,800

(22) Filed: Mar. 29, 2019

(51) Int. Cl. G06F 3/12

(52) U.S. Cl. CPC G06F 3/1261; G06F 3/1286; G06F 3/1215; G06F 3/1208

(57) ABSTRACT

Example systems and related methods relate to distributed printing. A first printing device can receive a print job with a first portion associated with first printing characteristics and a second portion associated with second printing characteristics, where the first and second printing characteristics can differ. A first page can be in both the first and second portions of the print job. The first printing device can generate a first portion of printed output according to the first printing characteristics. The first portion can include a first output page for the first page. The first portion can be provided to the second printing device. The second printing device can generate a second portion of printed output to complete the print job according to the second printing characteristics that includes the first portion, where the second portion includes the first output page after being further printed by the second printing device.

### BACKGROUND

Printing devices have increased in number and geographic footprint throughout the world and have become increasingly connected to networks. These networks can include a print server. Typically, when one or more documents and/or other print data are scheduled to be printed, the print data is either directly sent to one print device, or sent to a print server.

If the print data is sent directly to one print device, the print device completes a print job for printing the print data. If the print data is sent to a print server, the print server selects one or more print devices for the print job. Then, the print server sends the print data to the selected print devices for printing. The selected print devices print the print data and complete the print job.

### SUMMARY

One aspect of the present disclosure relates to a method. The method can include receiving, at a first printing device, a request for printing a print job having one or more pages. The print job can have a first portion that is eligible for printing on at least the first printing device and that is associated with a first set of printing characteristics and a second portion that is eligible for printing on at least a second printing device and that is associated with a second set of printing characteristics. The second set of printing characteristics can differ from the first set of printing characteristics. At least a first page of the one or more pages can be in both the first portion of the print job and the second portion of the print job. The method can include generating a first portion of printed output that partially completes the print job using the first printing device. The first portion of printed output can include a first output page that corresponds to the first page of the one or more pages. The first output page can be printed by the first printing device according to the first set of printing characteristics. The method can include providing the first portion of printed output to the second printing device. The method can include generating a second portion of printed output that completes the print job and that includes the first portion of printed output using the second printing device. The second portion of printed output can include the first output page having been further printed by the second printing device according to the second set of printing characteristics.

Another aspect of the present disclosure relates to a system. The system can include a first printing device and a second printing device. The first printing device can have one or more first processors and first data storage that includes first computer-readable instructions. The second printing device can have one or more second processors and second data storage that includes second computer-readable instructions. The first computer-readable instructions can be executed by the one or more first processors to cause the first printing device to perform first functions. The first functions can include: receiving a request for printing a print job having one or more pages, the print job having a first portion that is eligible for printing on at least the first printing device and that is associated with a first set of printing characteristics and a second portion that is eligible for printing on at least a second printing device and that is associated with a second set of printing characteristics, where the second set of printing characteristics can differ from the first set of printing characteristics, and where at least a first page of the one or more pages can be in both the first portion of the print job and the second portion of the print job, and generating a first portion of printed output that partially completes the print job, where the first portion of printed output can include a first output page that corresponds to the first page of the one or more pages, and where the first output page can be printed by the first printing device according to the first set of printing characteristics; and where after the first portion of printed output is provided to the second printing device, the second computer-readable instructions can be executed by the one or more second processors to cause the second printing device to perform second functions that can include: generating a second portion of printed output that completes the print job and that includes the first portion of printed output, where the second portion of printed output includes the first output page having been further printed by the second printing device according to the second set of printing characteristics.

Other aspects, embodiments, and implementations will become apparent to those of ordinary skill in the art by reading the following detailed description, with reference where appropriate to the accompanying drawings.

### BRIEF DESCRIPTION OF THE FIGURES

FIG. 1 is a schematic block diagram illustrating a computing device, in accordance with example embodiments.

FIG. 2 is a diagram illustrating a network, in accordance with example embodiments.

FIG. 3 is a flow diagram illustrating a method, in accordance with example embodiments.

FIG. 4 is a flow diagram illustrating procedures to generate printed output, in accordance with example embodiments.

FIG. 5 is a communication flow illustrating a scenario involving printing of a tandem print job, in accordance with example embodiments.

FIG. 6 is a diagram that illustrates example tandem print job output, in accordance with example embodiments.

FIG. 7 is a communication flow illustrating a scenario involving printing of a tandem print job where a print jam occurs, in accordance with example embodiments.

FIG. 8 is a flow diagram illustrating another method, in accordance with example embodiments.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

### I. Overview

The herein-described techniques related to tandem print jobs; that is, requests to print documents using two (or more) printing devices. One technique to print a tandem print job is to allocate certain pages to be printed on one printing device and certain pages to be printed on another printing device; e.g., print the first half of the tandem print job on one printing device and print the second half of the tandem print job on the other printing device. After both (or, more generally, all) printing devices have completed their portions of the tandem print job, a user can merge two (or, more generally, all) stacks of printed output together into one stack with pages arranged in the same order of pages in the document submitted for the tandem print job. This merging process can be extremely time consuming if number of pages to be printed is large.

To print a “color document” or document with one or more portions to be printed in color, the entire document can be printed on one color printing device. However, printing monochrome (i.e., black & white) portions of a color document on a monochrome printing device is likely to be more cost efficient than the monochrome portions of the document on a color printing device, because colorant (e.g., toner, dye) for color printing devices can be more expensive than colorant for a monochrome printing device. Therefore, printing an entire document having both color and monochrome portions using one color printing device may not be cost efficient.

To save costs in printing color documents with both color and monochrome portions, a tandem print job can be submitted to print the document. In some examples, a user selection can indicate whether a print job is to be classified as a tandem print job; e.g., a setting of a “Tandem Print Job” indicator equaling “Y” on a printer driver dialog or similar user interface technique. In some examples, one or more computing devices and/or printing devices can determine whether to classify a print job as a tandem print job based on aspects of the print job (e.g., job size, location, aspects of data to be printed, time to complete print job) aspects of printers available to service the print job (e.g., printer capacity, location, color/monochrome aspects, finishing devices), aspects related to a printing network (e.g., bandwidth, connectivity) and/or other aspects. After a print job is submitted and classified as a tandem print job, two (or more) printing devices having different attributes can be assigned to print the tandem print job—for example, suppose a first printing device and a second printing device are assigned to print the tandem print job. Once a first printing device has completed printing its portion of the tandem print job, the output of the first printing device can be provided to the second printing device assigned to the tandem print job as the second printing device to use during printing of the tandem print job. By having the second printing device print using the output of the first printing device, merging of pages can be avoided.

The second printing device can print its portion of the tandem print job on the output of the first printing device. For example, the first printing device can communicate to the second printing device which pages of the tandem print job have already been printed, so that the second printing device only prints the set of pages not previously printed by the first printing device. And, the second printing device can be informed which of its input tray contains the (paper) output of the first printing device so that the second printing device can receive and print to the (paper) output of the first printing device.

The second printing device can be a “different-attribute” printing device with respect to the first printing device. As an example in the context of printing color documents, a color printing device can have an attribute of being able to print in color that is different from an attribute of a monochrome printing device of not being able to print in color; i.e., print in monochrome only. That is, if the first printing device has an attribute of being a monochrome printing device (or has an attribute of being a color printing device), then the second printing device can be a different-attribute color printing device (or can be a different-attribute monochrome printing device). As another example, two printing devices can have different types of paper (e.g., letter, legal, A3, A4, letterhead) available at a given time, and so the two printing devices can be different-attribute printing devices with respect to available paper type. Other examples of tandem print jobs using other different-attribute printing devices are possible as well.

To determine which portions of tandem print job are to be printed by printing devices assigned to a tandem print job, a printing device selected to print a first portion of a tandem print job can use a raster image processor (RIP) and/or other component to scan each pixel of a page of a document to be printed. If each pixel of a page is a monochrome pixel, then the page is a monochrome page and can be printed by a monochrome printing device. Otherwise, at least one pixel of the page is not a monochrome pixel, and so the page is a non-monochrome page that has to be printed at least in part by a color printing device. Then, a monochrome printing device can print at least the monochrome pages of a tandem print job, and a color printing device can print the remainder of the tandem print job. In some examples, pages can be divided into portions or other subdivisions—then, a monochrome portion of a non-monochrome page can be printed by a monochrome printing device and the non-monochrome portion (or portions) of the non-monochrome page(s) can be printed by a color printing device.

In some cases, a facility can have more monochrome printing devices than color printing devices. Then, splitting monochrome pages of a tandem print job among multiple monochrome printing devices can speed up printing time further. Also, if a color printing device is low on black colorant used to print monochrome pages, using tandem print jobs to print color pages (and/or portions thereof) separately from monochrome pages can save black colorant of the color printing device by printing monochrome pages of the tandem print job on one or more monochrome printing devices and only printing color pages on the color printing device.

The herein-described techniques related to tandem print job printing using different-attribute printers can save costs, black colorant, maintenance, and wear and tear on color printing devices when the tandem print job includes documents with both monochrome and non-monochrome pages. Also, by dividing a print job among multiple devices, the print job may be printed faster than if just one device printed the entire print job. By printing color output on previously-printed monochrome pages for the tandem print job and/or by printing monochrome output on previously-printed non-monochrome pages for the tandem print job, the herein-described techniques can improve printing performance significantly by eliminating the mundane task of merging pages. That is, because each printing device accepts the same stack of paper as input; merging pages can be avoided as there is no separation of pages into two stacks in the first place.

### II. System Examples

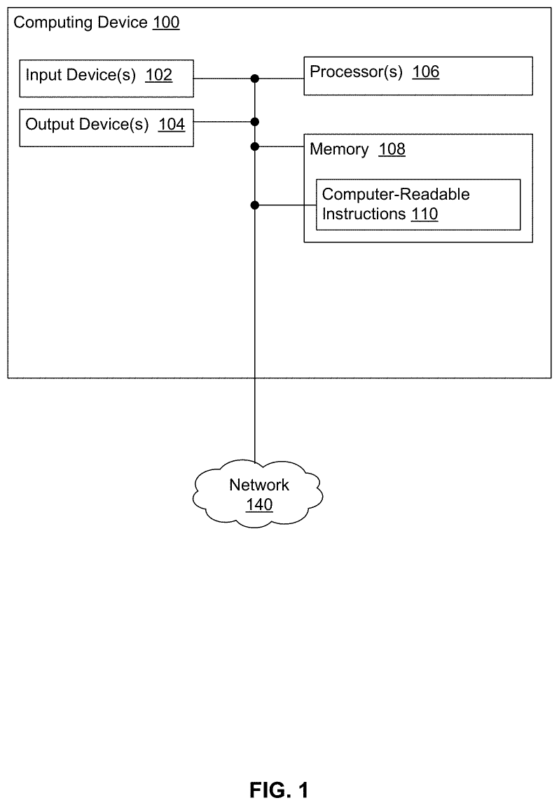

FIG. 1 is a schematic block diagram illustrating computing device 100, in accordance with example embodiments. In some embodiments, computing device 100 can be configured to perform at least part of the herein-described techniques for document distribution and/or functionality related to: a tandem print job, a color printing device, a monochrome printing device, a distributed storage system, networks 140, 200, scanning/printing devices (SPDs) 210, 212, 214, 216, computing devices 220, 222, print server node(s) 230, distributed storage system 232, methods 300, 800, scenarios 500, 700, and diagram 600.

Computing device 100 can include one or more input devices 102, one or more output devices 104, one or more processors 106 and memory 108 and can be connected to a network, such as network 140. Input devices 102 can include user input devices, network input devices, sensors, and/or other types of input devices. For example, input devices 102 can include user input devices such as a touch screen, a keyboard, a keypad, a computer mouse, a track ball, a joystick, a camera, a voice recognition module, and/or other similar devices. Network input devices can include wired network receivers and/or transceivers, such as an Ethernet® transceiver, a Universal Serial Bus (USB) transceiver, or similar transceiver configurable to communicate via a twisted pair wire, a coaxial cable, a fiber-optic link, or a similar physical connection to a wireline network, such as wired portions of one or more of networks 140, 200 and/or wireless network receivers and/or transceivers, such as a Bluetooth® transceiver, a ZigBee® transceiver, a Wi-Fi® transceiver, a WiMAX™ transceiver, a wireless wide-area network (WWAN) transceiver and/or other similar types of wireless transceivers configurable to communicate via a wireless network, such as wireless portions of one or more of networks 140, 200.

Output devices 104 can include user display devices, audible output devices, network output devices, and/or other types of output devices. User display devices can include one or more printing components, liquid crystal displays (LCD), light emitting diodes (LEDs), lasers, displays using digital light processing (DLP) technology, cathode ray tubes (CRT), light bulbs, and/or other similar devices. Audible output devices can include a speaker, speaker jack, audio output port, audio output device, headphones, earphones, and/or other similar devices. Network output devices can include wired network transmitters and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network, such as wired portions of one or more of networks 140, 200 and/or wireless network transmitters and/or transceivers, such as a Bluetooth® transceiver, a ZigBee® transceiver, a Wi-Fi® transceiver, a WiMAX™ transceiver, a wireless wide-area network (WWAN) transceiver and/or other similar types of wireless transceivers configurable to communicate via a wireless network, such as wireless portions of one or more of networks 140, 200. Other types of output devices can include, but are not limited to, vibration devices, haptic feedback devices, and non-visible light emission devices; e.g., devices that emit infra-red or ultra-violet light. Other output devices 104 are possible as well.

Processor(s) 106 can include one or more general purpose processors, central processing units (CPUs), CPU cores, and/or one or more special purpose processors (e.g., graphics processing units (GPUs), digital signal processors (DSPs), field programmable gated arrays (FPGAs), application specific integrated circuits (ASICs), etc.). Processor(s) 106 can be configured to execute computer-readable instructions 110 that are contained in memory 108 and/or other instructions as described herein.

Memory 108 can include one or more computer-readable storage media configured to store data and/or instructions that can be read and/or accessed by at least one of processor(s) 106. The one or more computer-readable storage media can include one or more volatile and/or non-volatile storage components, such as optical, magnetic, organic or other memory or disc storage, which can be integrated in whole or in part with at least one of processor(s) 106. The computer-readable storage media can include one or more components that store data for short periods of time like register memories, processor caches, and/or random access memories (RAM). The computer-readable storage media can include non-transitory computer readable media that stores program code and/or data for longer periods of time, such as secondary or persistent long term storage; for example, read only memory (ROM), optical or magnetic disks, compact-disc read only memory (CD-ROM). In some embodiments, memory 108 can be implemented using a single physical device (e.g., one optical, magnetic, organic or other memory or disk storage unit), while in other embodiments, memory 108 can be implemented using two or more physical devices.

Memory 108 can store computer-readable instructions 110 that, when executed by one or more of processor(s) 106, can cause a computing device (e.g., computing device 100) to perform functions, such as but not limited to, functions related to herein-described procedures, techniques, devices, networks, methods, features, and/or scenarios. In some examples, computer-readable instructions 110 can include instructions to carry out at least part of the herein-described functionality of a tandem print job, a color printing device, a monochrome printing device, a distributed storage system, a node, a print server node, and/or a network.

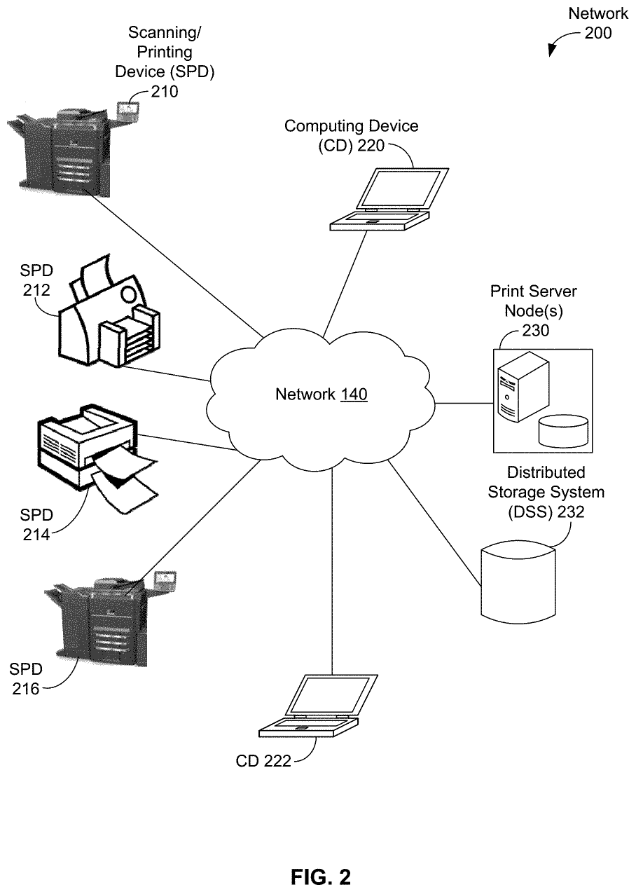

FIG. 2 is a diagram illustrating network 200, in accordance with example embodiments. Network 200 includes scanning/printing devices 210, 212, 214, 216, computing devices 220, 222, one or more print server nodes 230, and/or distributed storage system 232. In some examples, network 200 can have more, fewer, and/or different types of nodes, scanning/printing devices, computing devices, print server nodes, and/or other devices than indicated in FIG. 2. In some examples, network 200 is a peer-to-peer network with scanning/printing devices 210, 212, 214, 216, computing devices 220, 222, print server node(s) 230 and distributed storage system 232 acting as peers while being connected by network 140.

Scanning/printing devices 210, 212, 214, 216 can include components configured to scan, print, copy, e-mail, account for, communicate and/or otherwise process documents and/or files that are originally available either on paper or electronically. For example, some or all of scanning/printing devices 210, 212, 214, 216 can include scanning components for creating electronic copies of original paper documents and/or for generating electronic data via OCR or other techniques from the original paper documents; e.g., generating paper-form data from a paper form or other paper document. After processing by one or more of scanning/printing devices 210, 212, 214, 216, the paper-form data, documents, and/or files can be subsequently available either on paper or electronically, as requested. That is, scanning/printing devices 210, 212, 214, 216 can process a paper document PAPERD or electronic document ED by at least: creating an electronic document ED1 representing the contents of PAPERD (e.g., scan PAPERD to create ED1), making one or more paper copies of PAPERD, printing one or more copies of ED and/or ED1 on one or more types of paper, make one or more electronic copies of ED and/or ED1, change a format of ED and/or ED1 (e.g., perform OCR) scanning, convert a file format used to store ED and/or ED1), maintain remotely-accessible storage (e.g., a document box) enabling other devices than scanning/printing devices 210, 212, 214, 216 to use/access ED and/or ED1, and/or communicate the contents of ED and/or ED1 to/from another device. In some cases, creating the electronic document ED1 representing the contents of PAPERD can include creating paper-form data PFD representing part or all of the contents of PAPERD.

In some examples, scanning/printing devices 210, 212, 214, 216 can perform other tasks and/or other processing as well. Scanning/printing devices 210, 212, 214, 216 can include products from various manufacturers with variations in color, speed, computing power, functionality, network connectivity, and/or other features. For example, at least one of scanning/printing devices 210, 212, 214, 216 can be a color printing device and at least one of scanning/printing devices 210, 212, 214, 216 that is not a color printing device can be a monochrome printing device. As such, scanning/printing devices 210, 212, 214, 216 can include at least two different-attribute printing devices with respect to color printing.

In some examples, some or all of scanning/printing devices 210, 212, 214, 216 can be connected to network 140 through one or more, possibly different, network protocols. Data can be transmitted between scanning/printing devices 210, 212, 214, 216, computing devices 220, 222, print server node(s) 230 and/or distributed storage system 232, over wired and/or wireless links between computers, computing devices, nodes, printing devices, scanning/printing devices, servers, and network 140. The format of each respective data transmission between devices in network 200 can include one or more of a variety of different formats including: text formats, image formats, extensible mark-up language (XML), Simple Network Maintenance Protocol (SNMP) formats, database tables, text including OCR'd text, a flat file format, or another format.

Communications between the computers, computing devices, nodes, printing devices, scanning/printing devices, servers, can include: computing devices 220, 222, print server node(s) 230 and/or distributed storage system 232, sending and/or receiving data for scanning and printing jobs performed by scanning/printing devices 210, 212, 214, 216; scanning/printing devices 210, 212, 214, 216 sending alert, status, error, device information, colorant-usage information, print job information (including but not limited to information about tandem print jobs), maintenance-event information, and/or other messages to computing device 220 and/or computing device 222; and a document management system (not shown in FIG. 2) to inform other devices about print jobs, colorant-usage, maintenance, error, and/or other conditions of the printing devices and/or scanning/printing devices; e.g., idle, printing, sleeping, paper jam, low or out of paper, low or out of toner/ink, etc.; and scanning/printing devices 210, 212, 214, 216, computing devices 220, 222, print server node(s) 230 and/or distributed storage system 232, sending and/or receiving data related to securely storing and/or retrieving documents as described herein. Other communications between nodes, computing devices, scanning/printing devices 210, 212, 214, 216, computing devices 220, 222, print server node(s) 230 and/or distributed storage system 232, are possible as well, such as, but not limited to, communications related to one or more maintenance and management operations.

In some examples, computing devices 220, 222 can create, obtain, update, display, distribute, store, retrieve, and/or delete documents using network 200. For example, computing device 220 and/or computing device 222 can act as a herein-described print server node and/or act as part or all of a distributed storage system.

Print server node(s) 230 can include one or more computing devices, each acting as one or more herein-described print server nodes at least to act as a print server; that is, act to receive print jobs—including tandem print jobs—from computing devices (e.g., computing devices 220, 222) and to provide the print jobs to printing devices (e.g., scanning/printing devices 210, 212, 214, 216) for printing and perhaps other processing. In some examples, some or all of print server node(s) 230 can spool, store, and/or queue print jobs until one or more printing devices are available to print and perhaps otherwise process the print jobs. In some examples, some or all of print server node(s) 230 can also be part of distributed storage system 232.

Distributed storage system 232 can provide storage at least for a distributed storage system utilized by the herein-described techniques for process recording. In some examples, distributed storage system 232 can communicate with one or more other computing and/or data storage devices that can provide storage for one or more distributed storage systems utilized by the herein-described process recording techniques. Other data can be communicated using network 200 as well.

In some embodiments, one or more additional computing devices, e.g., one or more servers, printing devices, scanning/printing devices, nodes, print server nodes, and/or other computing devices, can be used in network 200 to perform additional functions, such as functions for one or more document solutions, managed print services, and/or other functions.

III. Example Techniques for Printing using Multiple Printing Devices

A tandem print job can be a print job that can have multiple printing devices print and perhaps otherwise process data, such as, but not limited to, one or more documents. The tandem print job can include job instructions (e.g., instructions in XJDF or another job control language) that can be carried out by the multiple printing devices. For example, a tandem print job can include job instructions to instruct a color printing device to print only color portions of print data of the tandem print job, and to instruct a monochrome printing device to print monochrome portions of the print data of the tandem print job. In an example where the color portions of the tandem print job are printed first, a color printing device can print the color portions of the print data to paper output, the paper output of the color printing device can be provided as input to the monochrome printing device, and the monochrome printing device can print the monochrome portions of the print data on the paper output of the color printing device. In another example where the monochrome portions of the tandem print job are printed first, a monochrome printing device can print the monochrome portions of the print data to paper output, the paper output of the monochrome printing device can be provided as input to the color printing device, and the color printing device can print on the color portions of the print data on the paper output of the monochrome printing device. By printing monochrome portions of the print data on the paper output of a color printing device and/or printing color portions of the print data on the paper output of a monochrome printing device, the entire tandem print job can be printed without manually sorting the paper output, for either simplex print jobs or duplex print jobs.

In order for a printing device to print only color portions (for color printing devices) or only monochrome portions (for monochrome printing devices) of a tandem print job, each printing device can raster each page of the tandem print job to determine which portions of the tandem print job are to be printed by the printing device and which portions of the tandem print job are to be printed by a different printing device. In one use case, a print server node; e.g., print server node 230, can provide configuration data for the tandem print job (in XML, or another language) to all printing devices processing a tandem print job. The configuration data can indicate which pages (and/or portions of pages) are color pages (and/or portions of pages) to be printed by color printing device(s) processing the tandem print job and can indicate which pages (and/or portions of pages) are monochrome pages (and/or portions of pages) to be printed by monochrome printing device(s) processing the tandem print job. In another use case, a raster engine (and/or other components) in a color printing device first detects and print all color pages and refrains from printing monochrome pages. Then, the color printing device can forward a configuration file and the tandem print job to a monochrome printing device, which can then use the configuration file to determine and print the monochrome pages of the tandem print job. In a related use case, a raster engine (and/or other components) in a monochrome printing device first detects and prints all monochrome pages and refrains from printing color pages. Then, the monochrome printing device can forward a configuration file and the tandem print job to a color printing device, which can then use the configuration file to determine and print the color pages of the tandem print job. In some examples, a log of portions of a document printed for the tandem print job can be maintained and a last (e.g., second) printing device can use the log to ensure that the entire tandem print job is actually printed; for example, by printing each portion of the document printed for the tandem print job that was not listed in the log of portions.

A printing device can refrain from printing a page by substituting all “white pixels” for the page; that is, printing a page whose pixels all have zeroes for their color values (e.g., zeroes for C, M, Y, and K pixel values of a page that uses a cyan-yellow-magenta-black (CYMK) color space, zeroes for all R, and B pixel values of a page that uses a red-green-blue (RGB) color space). The net effect of substituting all white pixels is that the page becomes 100% white, effectively refraining from printing the page and no colorant is used on the page. Another technique to refrain from printing a page is to provide a signal; e.g., using an interpreter of the printing device, to a printer engine not to put any marks on the page, thereby refraining from printing on the page. In some examples, similar techniques can be used to refrain from printing part of a page; e.g., to refrain from printing a region of pixels, all white pixels can be provided for the region and/or one or more commands can be provided to the printer engine to refrain from printing the region of pixels.

Pixel values can be used to determine whether to refrain from printing part or all of a page. Suppose that a monochrome printing device uses a CYMK color space. For the monochrome printing device to detect a region R1 of color pixels in a page P1 that are not to be printed by the printing device, the printing device can scan the pixels in R1 for non-zero C, M, and/or Y values, as a pixel with a non-zero C, M, and/or Y value is a color pixel. Then, if a threshold percentage (e.g., <1%, 80%, 90%, 95%, 100%) or more of the pixels in R1 are color pixels, the monochrome printing device can determine that region R1 is a region of color pixels and determine to refrain from printing region R1. Otherwise, less than the threshold percentage of the pixels in R1 are color pixels, and the monochrome printing device can determine that region R1 is a region of monochrome pixels and print region R1. In the case where R1 equals all of the pixels in P1, this technique can be used by a monochrome printing device to determine whether to refrain from printing all of page P1.

And, suppose that a color printing device uses a CYMK color space. For the color printing device to detect a region R2 of monochrome pixels in a page P2 that are not to be printed by the printing device, the printing device can scan R2 for each pixels where C=Y=M=0 as being monochrome pixels. Then, if a threshold percentage (e.g., <1%, 80%, 90%, 95%, 100%) or more of the pixels in R2 are monochrome pixels, the color printing device can determine that region R2 is a region of monochrome pixels and determine to refrain from printing region R2. Otherwise, less than the threshold percentage of the pixels in R2 are monochrome pixels, and the color printing device can determine that region R2 is a region of color pixels and print region R2. In the case where R2 equals all of the pixels in P2, this technique can be used by a color printing device to determine whether to refrain from printing all of page P2.

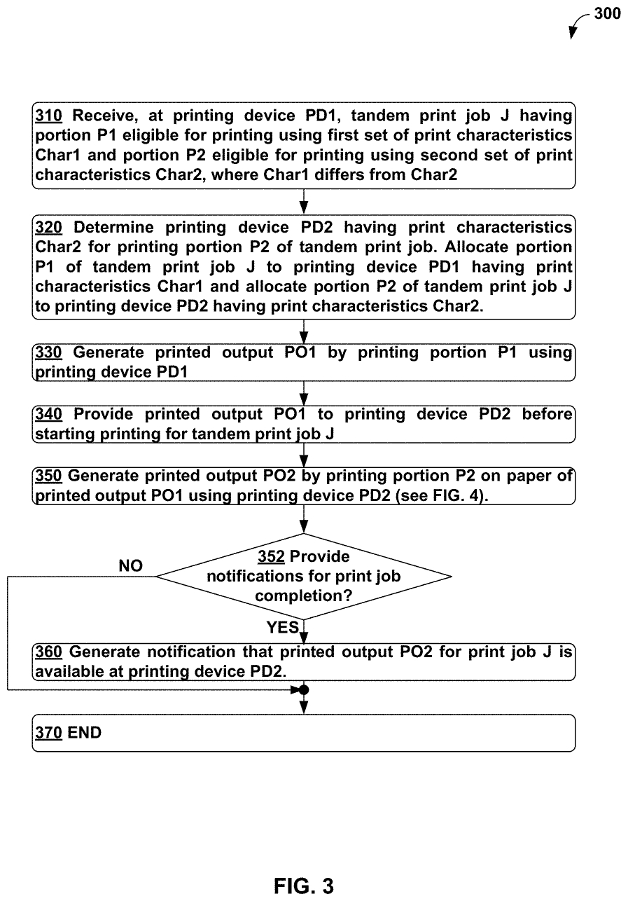

FIG. 3 is a flow diagram illustrating method 300, according to an example embodiment. Method 300 is a method for distributed printing of a tandem print job that can be carried out by at least two printing devices; e.g., two or more of scanning/printing devices 210, 212, 214, 216 connected by network 140. In this description of method 300 and in FIG. 3, the two printing devices are called PD1 and PD2.

Method 300 can begin at block 310, where printing device PD1 can receive tandem print job J having portion P1 eligible for printing using first set of print characteristics Char1 and portion P2 eligible for printing using second set of print characteristics Char2, where print characteristics Char1 can differ from print characteristics Char2. In one example, first set of print characteristics Char1 can include a first characteristic associated with a first type of printing that is a color type of printing and second set of print characteristics Char2 can include a second characteristic associated with a second type of printing that is a monochrome type of printing. In another example, first set of print characteristics Char1 can include a first characteristic associated with a first type of printing that is a monochrome color type of printing and second set of print characteristics Char2 can include a second characteristic associated with a second type of printing that is a color type of printing. Many other examples of sets of print characteristics Char1 and Char2 are possible as well.

At block 320, printing device PD1 can determine printing device PD2 having print characteristics Char2 for printing portion P2 of tandem print job. Also, printing device PD1 can allocate portion P1 of tandem print job J to printing device PD1 (that is, to itself) as PD1 has print characteristics Char1 and can allocate portion P2 of tandem print job J to printing device PD2, as PD2 has print characteristics Char2.

At block 330, printing device PD1 can print portion P1 to paper to generate printed output P01. Note that printing device PD1 can refrain from printing portion P2 at block 330.

At block 340, printed output P01 can be provided to printing device PD2 before starting printing for tandem print job J. For example, printed output P01 can be transported by a person, robot, and/or other entity from printing device PD1 to printing device PD2. In some examples, printed output P01 can be placed in an input tray (or other receptacle for printed output/paper) of PD2; e.g., for use by PD2 in generating its own printed output.

At block 350, printing device PD2 can print portion P2 to paper generate printed output P02.

In some examples, portions P1 and P2 can be determined on a per-page basis; that is, if printing device PD1 (or PD2) is assigned to print a page of tandem print job J as part of portion P1 (or P2), then printing device PD1 (or PD2) can print the entire page of tandem print job J assigned to it. For example, suppose that tandem print job J has 10 pages where portions are assigned on a per-page basis, and where portion P1 includes pages 1, 3, and 7-10 and portion P2 includes pages 2 and 4-6. Then, at block 320, printing device PD1 can print portion P1 first by printing pages 1, 3, and 7-10 as printed output and can refrain from printing portion P2. In some examples, printing device PD1 can also include blank pages for the pages of portion P2 (e.g., pages 2 and 4-6) as part of the printed output. In other examples, printing device PD1 does not include blank pages for the pages of portion P2 (e.g., pages 2 and 4-6) as part of the printed output; rather printing device PD2 can use its own blank pages to print portion P2. Then, the printed output of printing device PD1 can be provided to printing device PD2 at block 340 and printing device PD2 can print the rest of tandem print job J (that is portion P2 having pages

In some examples, portions P1 and P2 can be determined on a partial-page basis; that is, if a threshold percentage (e.g., 1%, 80%, 90%, 95%, 100%) or more of the pixels in a region R1 of a page P_R1 of tandem print job J have characteristic Char2, printing device PD1 can determine that region R1 is a region of pixels have characteristic Char2 and so determine to refrain from printing region R1 on page P_R1. In particular examples, region R1 can be determined in a scanline basis; that is, region R1 can include one or more scanlines of pixels of a page of tandem print job J. A scanline can be a part or all of a row of pixels for a page; e.g., a page of pixels representing a page of tandem print job J.

Then, each scanline (or set of scanlines) in region R1 of tandem print job J can be determined to have characteristic Char1 (or characteristic Char2) based on the threshold percentages discussed above. If the scanline(s) in region R1 are determined to have characteristic Char1, then printing device PD1 can print the scanline(s) in region R1 as part of portion P1; otherwise, the scanline(s) in region R1 can be determined to have characteristic Char2 and printing device PD1 can print the scanline(s) in region R1 as part of portion P2.

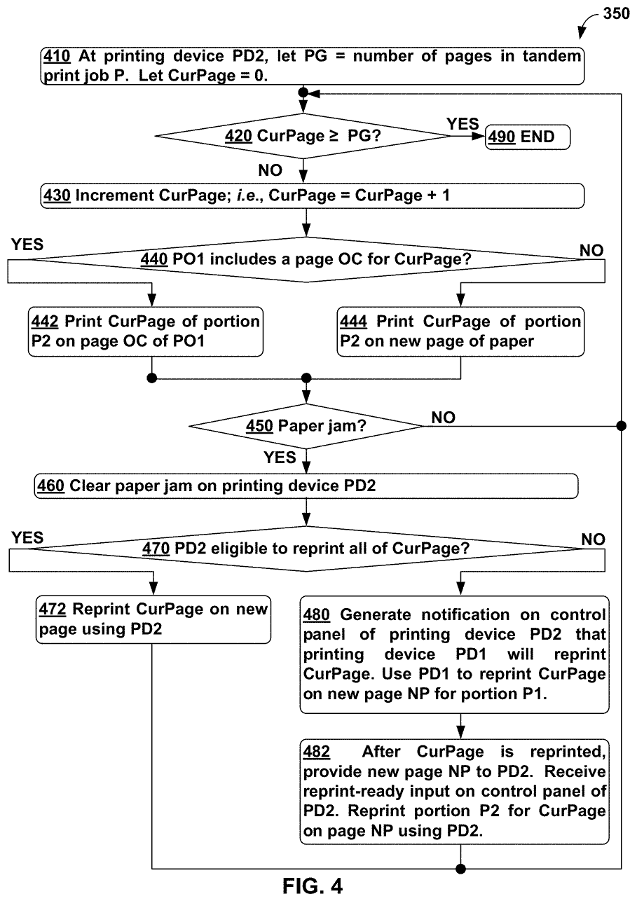

In some examples, printing device PD2 can use the procedures illustrated by FIG. 4 to generate printed output P02.

FIG. 4 is a flow diagram illustrating procedures for block 350 to generate printed output P02, in accordance with example embodiments. Procedures for block 350 illustrated on FIG. 4 can begin at block 410.

At block 410, printing device PD2 can execute a method in which a variable PG is equal to the number of pages in tandem print job P and a variable CurPage is equal to 0.

At block 420, printing device PD2 can determine whether CurPage is greater than or equal to PG If CurPage is greater than or equal to PG, then printing device PD2 can proceed to block 490. Otherwise, printing device PD2 can determine that CurPage is less than PG and can proceed to block 430.

At block 430, printing device PD2 can increment CurPage; that is, printing device PD2 can set CurPage=CurPage+1.

At block 440, printing device PD2 can determine if printed output P01 includes a paper page OC of output for CurPage. For example, printing device PD2 can examine a configuration file, job instructions, and/or use other techniques to determine if printed output P01 includes a paper page OC of output for CurPage. If printed output P01 includes a paper page OC of output for CurPage, then printing device PD2 can proceed to block 442

At block 442, printing device PD2 can print CurPage for portion P2 of tandem print job P on paper page OC for use as printed output for tandem print job J; that is, printing device PD2 can reuse the output for CurPage provided by printing device PD1 to complete the tandem print job P for page CurPage. Upon completion of block 442, printing device PD2 can proceed to block 450.

At block 444, printing device PD2 can print CurPage for portion P2 of tandem print job P on a paper page for use as printed output for tandem print job J; that is, printing device PD2 can provide paper for CurPage to make up for the missing paper page OC detected at block 440.

At block 450, printing device PD2 can determine whether printing device PD2 has a paper jam. If printing device PD2 has a paper jam, printing device PD2 can proceed to block 460. Otherwise, printing device PD2 can determine that printing device PD2 does not have a paper jam and so can proceed to block 420.

At block 460, the print jam on printing device PD2 can be cleared.

At block 470, printing device PD2 can determine whether printing device PD2 is eligible to reprint all of CurPage. For example, if printing device PD2 is a color printing device, then printing device PD2 is eligible to reprint all of CurPage regardless of whether CurPage has one or more monochrome portions. As another example, if printing device PD2 is a monochrome printing device, then printing device PD2 is eligible to reprint all of CurPage if CurPage is a monochrome page, but printing device PD2 is not eligible to reprint all of CurPage if CurPage has one or more color portions.

If printing device PD2 is eligible to reprint all of CurPage, then printing device PD2 can proceed to block 472. Otherwise, printing device PD2 can determine that PD2 is not eligible to reprint all of CurPage, and printing device PD2 can proceed to block 480.

At block 472, printing device PD2 can reprint CurPage for portion P2 of tandem print job P on a new paper page for use as printed output for tandem print job J, under the assumption that the paper jam detected at block 450 made CurPage unusable as printed output. Upon completion of the procedures of block 472, printing device PD2 can proceed to block 420.

At block 480, printing device PD2 can generate a notification on a control panel or other user interface (e.g., a front panel) of printing device PD2. The notification can indicate that printing device PD1 will reprint CurPage. Then, printing device PD1 can reprint CurPage on new page NP for portion P1; that is, the part of CurPage that would be printed as part of portion P1 can be reprinted by printing device PD1 on new page NP.

At block 482, after CurPage is reprinted by printing device PD1 on new page NP, new page NP with reprinted CurPage can be provided to printing device PD2. For example, new page NP can be provided to printing device PD2 using the techniques discussed above in the context of block 340. After new page NP is provided to PD2, PD2 can receive reprint-ready input on the control panel (or other user interface mentioned at block 480) of PD2. Then, the part of CurPage to be printed as part of portion P2 can be printed by printing device PD2 on new page NP. Upon completion of the procedures of block 482, printing device PD2 can proceed to block 420.

At block 490, the procedures for block 350 illustrated on FIG. 4 can end.

Returning to FIG. 3, at block 352, printing device PD2 can determine whether notifications for print job completion are to be provided. If notifications for print job completion are to be provided, printing device PD2 can proceed to block 360. Otherwise, printing device PD2 can determine that notifications for print job completion are not to be provided, and printing device PD2 can proceed to block 370.

At block 360, printing device PD2 can generate a notification that printed output P02 for print job J is available at printing device PD2.

At block 370, method 300 can be completed.

In some examples, at least part of method 300 can be carried out by a computing device, such as a print server node of print server node(s) 230. For example, at block 310, the print server node can receive tandem print job J and allocate printing devices PD1 and PD2 to print tandem print job J. Then, at block 320, the print server node can allocate portion P1 of tandem print job J to printing device PD1 and can portion P2 of tandem print job J to printing device PD2. Also, upon completion of block 350, the print server node can perform at least some of the procedures of blocks 352 and 360 regarding providing notifications related to the completion of the tandem print job J. In some examples, multiple printing devices having print characteristics Char 1 can act as printing device PD1 and/or multiple printing devices having print characteristics Char 2 can act as printing device PD2 to carry out method 300.

In some examples, the procedures of FIG. 4 can include determining whether multiple pages of the printed output are affected by the paper jam detected at block 450; e.g., printing device PD2 can receive an input as to how many pages and perhaps which specific pages of the printed output are affected by the paper jam. Then, the procedures of blocks 470 through 482 can be repeated to reprint all of the pages of the printed output affected by the paper jam. In a related example, the procedures of FIG. 4 can include determining whether no pages of the printed output are affected by the paper jam detected at block 450; then, if no pages of the printed output are affected by the paper jam, the procedures of blocks 470 through 482 can be omitted after completion of the procedures of block 460 are carried out to clear the paper jam.

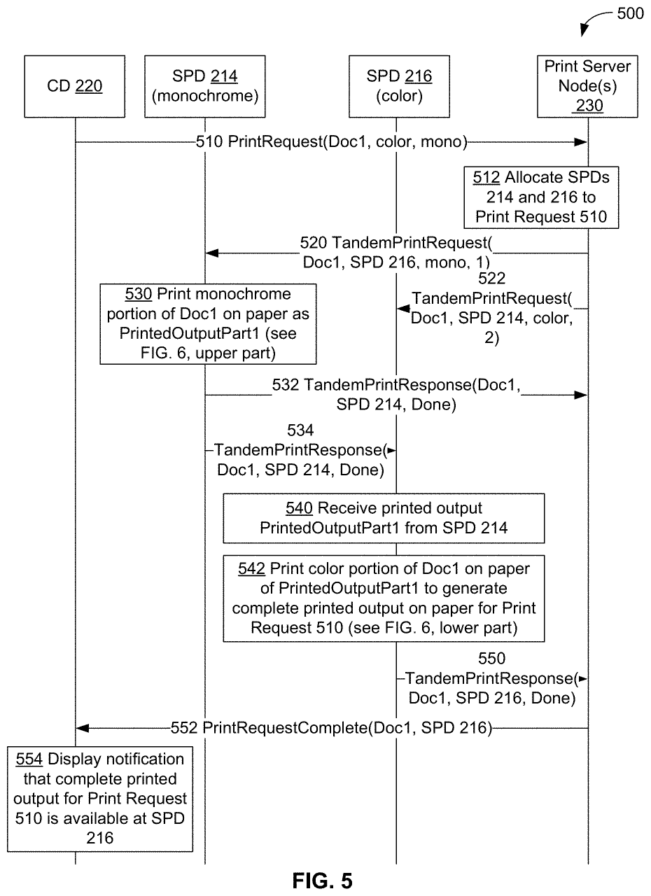

FIG. 5 is a communication flow illustrating scenario 500 involving printing of a tandem print job, in accordance with example embodiments. Scenario 500 involves using a variation of method 300 to carry out a tandem print job, where a node of print server node(s) 230 coordinates two printing devices—scanning/printing device 214 and scanning/printing device 216—to print respective monochrome and color portions of document “Doc1”.

Scenario 500 begins with computing device 220 generating and sending print request 510 to print server node(s) 230 to print a document “Doc1” having both “color” and “mono” (monochrome) characteristics. In related scenarios, computing device 220 can send print request 510 directly to a printing device, such as scanning/printing device 214 or scanning/printing device 216, for processing.

Upon reception of print request 510, print server node(s) 230 carries out the procedures of block 512 to allocate scanning/printing device 214 and scanning/printing device 216 to carry out print request 510. In scenario 500, scanning/printing device 214 and scanning/printing device 216 carry out print request 510 by carrying out a tandem print job, where scanning/printing device 214 first prints the monochrome portion of Doc 1 and scanning/printing device 216 prints the color portion of Doc1 on the paper output that scanning/printing device 214 produced for the monochrome portion of Doc1.

Print server node(s) 230 then generates and sends a tandem print job to carry out print request 510. The tandem print job is formulated in scenario 500 as two messages: (1) tandem print message 520 from print server node(s) 230 to scanning/printing device 214 to print a “mono” portion of “Doc1” first (as indicated by the “1” as the last parameter of tandem print message 520) in conjunction with printing device “SPD 216”; and (2) tandem print message 522 from print server node(s) 230 to scanning/printing device 216 to print a “color” portion of “Doc 1” second (as indicated by the “2” as the last parameter of tandem print message 522) in conjunction with printing device “SPD 214”.

Upon reception of tandem print message 520, scanning/printing device 214 carries out the procedures of block 530 to print the monochrome portion of Doc 1 on paper as PrintedOutputPart1.

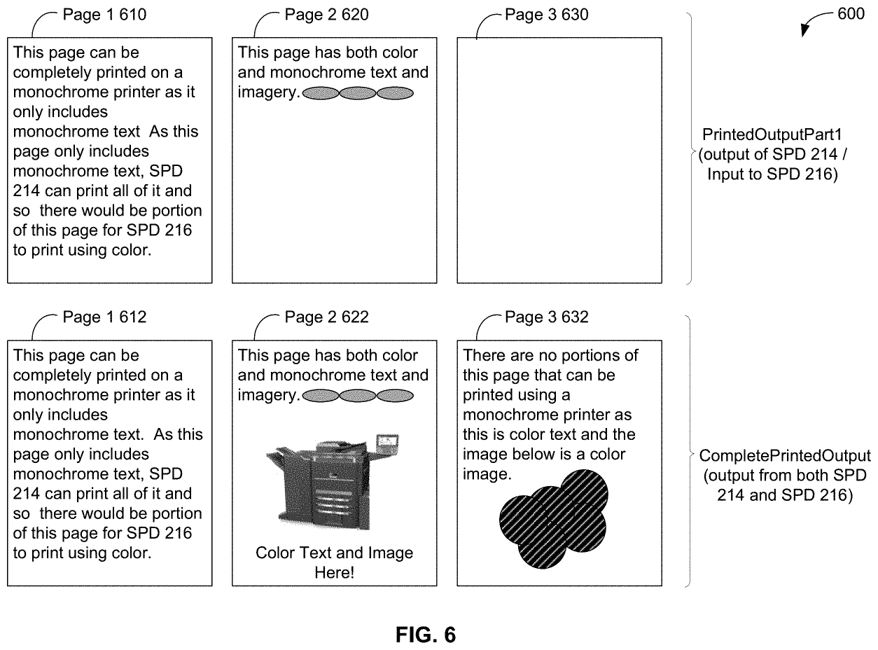

FIG. 6 is a diagram 600 that illustrates example tandem print job output for scenario 500, in accordance with example embodiments. An upper portion of diagram 600 shows PrintedOutputPart1, which is a monochrome portion of Doc1 printed to paper by scanning/printing device 214 at block 530 as part of a tandem print job to carry out print request 510.

PrintedOutputPart1 has three pages: Page 1 610 shown at upper left of FIG. 6, Page 2 620 shown at upper center of FIG. 6, and Page 3 630 shown at upper right of FIG. 6. In scenario 500, Page 1 610 is a monochrome page and so is completely printed by scanning/printing device 214 at block 530. Page 2 620 is a page having both monochrome and color portions, and so is partially printed by scanning/printing device 214 at block 530. In particular, FIG. 6 shows that scanning/printing device 214 printed a monochrome portion of Page 2 620 that includes three monochrome ellipses as monochrome imagery and monochrome text that reads “This page has both color and monochrome text and imagery.” Page 3 630 is a color page that was not printed by scanning/printing device 214 at block 530; rather, scanning/printing device 214 provided a blank page as part of PrintedOutputPart1 for use by scanning/printing device 216 in printing the color portion of Doc1/print request 510.

Returning to FIG. 5, after printing PrintedOutputPart1, scanning/printing device 214 sends messages 532 and 534 to print server node(s) 230 and scanning/printing device 216, respectively. Each of messages 532 and 534 is a tandem print response message indicating that “SPD 214” (scanning/printing device 214) is “Done” printing its portion of “Doc1”.

Then, at block 540, the three paper pages of PrintedOutputPart1 are received at scanning/printing device 216. For example, the three paper pages of PrintedOutputPart1 can be transported by a person, robot, or other entity from scanning/printing device 214 to scanning/printing device 216. In scenario 500, the three paper pages of PrintedOutputPart1 are placed in an input paper tray of scanning/printing device 216 for use in carrying out scanning/printing device 216's portion of print request 510.

At block 542, scanning/printing device 216 prints the color portion of print request 510/Doc1 by: receiving each paper page of PrintedOutputPart1 via the input paper tray mentioned at block 540, printing the color portion (if any) for the page of print request 510 on the paper page of PrintedOutputPart1, and subsequently outputting the paper page printed with both the monochrome and color portions of print request 510/Doc1. Then, after three paper pages of PrintedOutputPart1 are printed with the color portion of print request 510/Doc1, the complete printed output for print request 510 is available at scanning/printing device 216.

A lower portion of diagram 600 shows the complete printed output for print request 510 that includes both the monochrome and color portions of Doc 1 printed to paper by scanning/printing device 214 at block 530 and by scanning/printing device 216 at block 542, respectively.

The complete printed output for print request 510 has three pages: Page 1 612 shown at lower left of FIG. 6, Page 2 622 shown at lower center of FIG. 6, and Page 3 632 shown at lower right of FIG. 6. As Page 1 612 is a monochrome page, it was completely printed by scanning/printing device 214 at block 530 and so Page 1 610 output by scanning/printing device 214 is the same as Page 1 612 output by scanning/printing device 216.

Page 2 622 is a page having both monochrome and color portions, and so is partially printed by scanning/printing device 216 at block 542. In particular, FIG. 6 shows that scanning/printing device 216 printed a color portion of Page 2 622 that includes a color image of a printing device and color text (greyscale rather than actual color used in FIG. 6 to represent the color portion of print request 510/Doc 1). The color text of Page 2 622 reads “Color Text and Image Here!” Page 2 622 also includes the three monochrome ellipses and monochrome text previously printed by scanning/printing device 214. Then, as Page 2 622 includes both monochrome and color portions, Page 2 622 was printed by both scanning/printing device 214 and scanning/printing device 216, respectively.

Page 3 632 is a color page that was completely printed by scanning/printing device 216 at block 542 using the blank page output by scanning/printing device 214 at block 530. FIG. 6 shows that scanning/printing device 216 printed Page 3 632 with five color circles printed as color imagery and color text of “There are no portions of this page that can be printed using a monochrome printer as this is color text and the image below” (of the five circles) “is a color image.”

Returning to FIG. 5, after printing the complete printed output for print request 510, scanning/printing device 216 sends tandem print response message 550 to print server node(s) 230 to indicating that “SPD 216” (scanning/printing device 216) is “Done” printing its portion of “Doc1”. After receiving tandem print response message 550, print server node(s) 230 sends print request complete message 552 to computing device 210 to indicate that “Doc1” has been printed (and so print request 510 has been completed) and the complete printed output is available at “SPD 216”. After receiving print request complete message 552, computing device uses the procedures of block 554 to display a notification that the complete printed output for print request 510 is available at scanning/printing device 216. Upon completion of the procedures of block 554, scenario 500 can be completed.

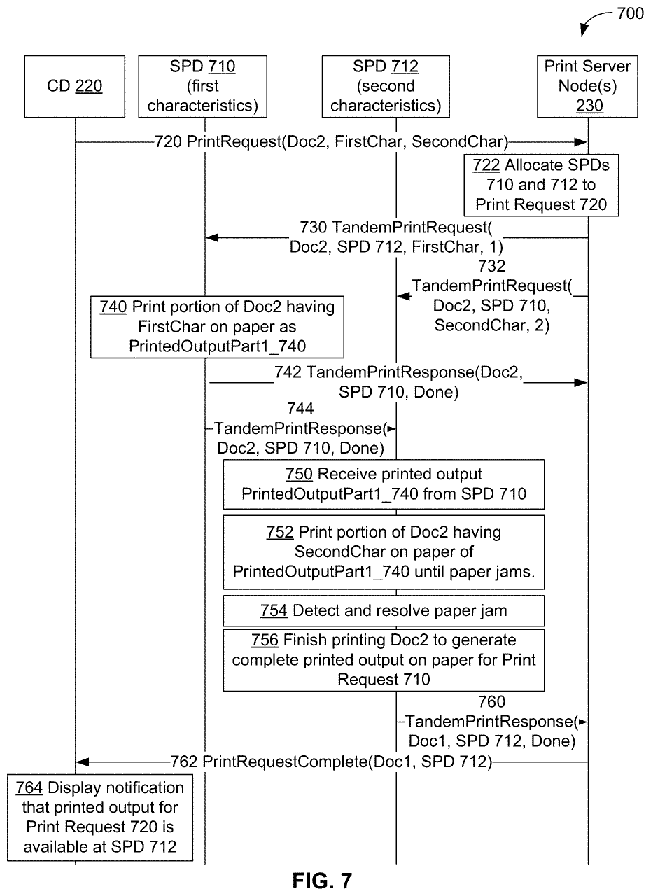

FIG. 7 is a communication flow illustrating scenario 700 involving printing of a tandem print job where a print jam occurs, in accordance with example embodiments. Scenario 700 involves using a variation of method 300 to carry out a tandem print job, where a node of print server node(s) 230 coordinates two printing devices—scanning/printing device 710 and scanning/printing device 712—to carry out a print request to print respective portions of document “Doc2”. In scenario 700, scanning/printing device 710 has a first print characteristic and scanning/printing device 712 has a second print characteristic, and scanning/printing device 710 is a different-attribute printing device from scanning/printing device 712 with respect to the first print characteristic and the second print characteristic. For example, scanning/printing device 710 can have a first print characteristic of being a color (or monochrome) printing device and different-attribute scanning/printing device 712 can have a second print characteristic of being a monochrome (or color) printing device. Other examples of the first print characteristic being an opposite attribute from the second print characteristic are possible as well.

Scenario 700 begins with computing device 220 generating and sending print request 720 to print server node(s) 230 to print a document “Doc2” having both “FirstChar” (first print characteristic) and “SecondChar” (second print characteristic) characteristics. In related scenarios, computing device 220 can send print request 720 directly to a printing device, such as scanning/printing device 710 or scanning/printing device 712, for processing.

Upon reception of print request 720, print server node(s) 230 carries out the procedures of block 722 to allocate scanning/printing device 710 and scanning/printing device 712 to carry out print request 720. In scenario 700, scanning/printing device 710 and scanning/printing device 712 carry out print request 720 by carrying out a tandem print job, where scanning/printing device 710 first prints the first print characteristic portion of Doc2 and scanning/printing device 712 prints the second print characteristic portion of Doc2 on the paper output that scanning/printing device 710 produced for the first print characteristic portion of Doc2.

Print server node(s) 230 then generates and sends a tandem print job to carry out print request 720. The tandem print job is formulated in scenario 700 as two messages: (1) tandem print message 730 from print server node(s) 230 to scanning/printing device 710 to print a “FirstChar” portion of “Doc2” first (as indicated by the “1” as the last parameter of tandem print message 730) in conjunction with printing device “SPD 712”; and (2) tandem print message 732 from print server node(s) 230 to scanning/printing device 712 to print a “SecondChar” portion of “Doc2” second (as indicated by the “2” as the last parameter of tandem print message 732) in conjunction with printing device “SPD 710”.

Upon reception of tandem print message 730, scanning/printing device 710 carries out the procedures of block 740 to print the first print characteristic portion of Doc2 on paper as PrintedOutputPart1 740.

After printing PrintedOutputPart1 740, scanning/printing device 710 sends messages 742 and 744 to print server node(s) 230 and scanning/printing device 712, respectively. Each of messages 742 and 744 is a tandem print response message indicating that “SPD 710” (scanning/printing device 710) is “Done” printing its portion of “Doc2”.

Then, at block 750, the paper pages of PrintedOutputPart1 740 are received at scanning/printing device 712. For example, the three paper pages of PrintedOutputPart1 740 can be transported by a person, robot, or other entity from scanning/printing device 710 to scanning/printing device 712. In scenario 700, the paper pages of PrintedOutputPart1 740 are placed in an input paper tray of scanning/printing device 712 for use in carrying out scanning/printing device 712's portion of print request 720.

At block 752, scanning/printing device 712 attempts to prints the second print characteristic portion of print request 720/Doc2 by: receiving each paper page of PrintedOutputPart1_740 via the input paper tray mentioned at block 750, printing the second print characteristic portion (if any) for the page of print request 720 on the paper page of PrintedOutputPart1_740, and subsequently outputting the paper page printed with both the first print characteristic and second print characteristic portions of print request 720/Doc2.

However, during scenario 700, a paper jam occurs on scanning/printing device 712 while printing the second print characteristic portion of print request 720/Doc2. Then, at block 754, the paper jam of scanning/printing device 712 is detected and resolved so that scanning/printing device 712 can continue printing the second print characteristic portion of print request 720/Doc2. In scenario 700, one page is jammed and rendered unusable for printing; scanning/printing device 712 is eligible to reprint the jammed page; and so scanning/printing device 712 can use the procedures of block 472 to reprint the jammed page.

At block 756, scanning/printing device 712 subsequently continues and finishes printing the second print characteristic portion (if any) for the page of print request 720 on each remaining paper page of PrintedOutputPart1 740, and subsequently outputting the paper page printed with both the first print characteristic and second print characteristic portions of print request 720/Doc2. Then, the complete printed output for print request 720 is available at scanning/printing device 712.

After printing the complete printed output for print request 720, scanning/printing device 712 sends tandem print response message 760 to print server node(s) 230 to indicating that “SPD 712” (scanning/printing device 712) is “Done” printing its portion of “Doc2”. After receiving tandem print response message 760, print server node(s) 230 sends print request complete message 762 to computing device 210 to indicate that “Doc2” has been printed (and so print request 720 has been completed) and the complete printed output is available at “SPD 712”. After receiving print request complete message 762, computing device uses the procedures of block 764 to display a notification that the complete printed output for print request 720 is available at scanning/printing device 712. Upon completion of the procedures of block 764, scenario 700 can be completed.

### IV. Example Methods of Operation

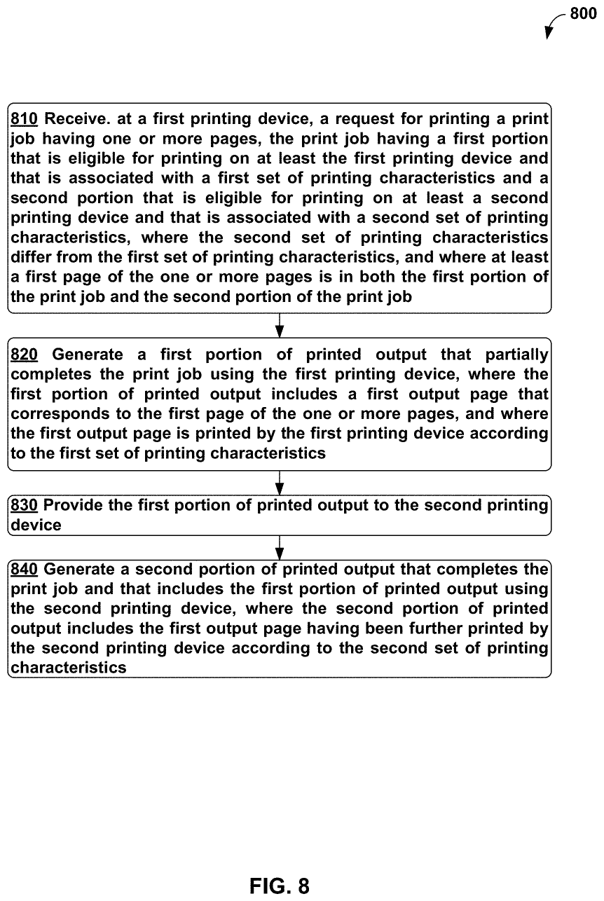

FIG. 8 is a flow diagram illustrating method 800, in accordance with example embodiments. Method 800 can be carried out by a first printing device and a second printing device, such as two or more of scanning/printing devices 210, 212, 214, 216, and one or more computing device 100 configured as one or more printing devices.

Method 800 can begin at block 810, where the first printing device can receive a request for printing a print job having one or more pages, the print job having a first portion that is eligible for printing on at least the first printing device and that is associated with a first set of printing characteristics and a second portion that is eligible for printing on at least a second printing device and that is associated with a second set of printing characteristics, where the second set of printing characteristics can differ from the first set of printing characteristics, and where at least a first page of the one or more pages can be in both the first portion of the print job and the second portion of the print job, such as discussed above in the context of at least FIGS. 3 and 5-7.

At block 820, the first printing device can generate a first portion of printed output that partially completes the print job, where the first portion of printed output can include a first output page that corresponds to the first page of the one or more pages, and where the first output page is printed by the first printing device according to the first set of printing characteristics, such as discussed above in the context of at least FIGS. 3 and 5-7.

At block 830, the first portion of the printed output can be provided to the second printing device, such as discussed above in the context of at least FIGS. 3, 5, and 7.

At block 840, the second printing device can generate a second portion of printed output that completes the print job and that can include the first portion of printed output, where the second portion of printed output can include the first output page having been further printed by the second printing device according to the second set of printing characteristics, such as discussed above in the context of at least FIGS. 3-7.

In some examples, the first set of printing characteristics can be associated with a first type of printing that is either a color type of printing or a monochrome type of printing; the second set of printing characteristics can be associated with a second type of printing; the second type of printing can be the color type of printing when the first type of printing is the monochrome type of printing; the second type of printing can be the monochrome type of printing when the first type of printing is the color type of printing; where generating the first portion of printed output that partially completes the print job using the first printing device can include generating the first portion of printed output using the first printing device to perform the first type of printing; and generating the second portion of printed output that completes the print job and that includes the first portion of printed output using the second printing device can include generating the second portion using the second printing device to perform the second type of printing, such as discussed above in the context of at least FIGS. 3-6.

In some examples, the one or more pages can include a second page that is not part of the first portion and that is part of the second portion; generating the first portion of printed output that partially completes the print job using the first printing device can include printing a blank page representing the second page as part of the first portion of printed output; and generating the second portion of printed output that includes the first portion of printed output using the second printing device can include printing the second page on the blank page representing the second page as part of the second portion of printed output, such as discussed above in the context of at least FIGS. 3, 5, and 6.

In some examples, the one or more pages can include a second page that is not part of the first portion and that is part of the second portion; generating the first portion of printed output that partially completes the print job using the first printing device can include refraining from printing the second page as part of the first portion of printed output; and generating the second portion of printed output that includes the first portion of printed output using the second printing device can include: printing a first sub-portion of the second portion that can include all of the one or more pages that are to be printed before the second page, printing the second page on a page that is not part of the first portion of printed output, and printing a second sub-portion of the second portion that can include all of the one or more pages that are to be printed after the second page, such as discussed above in the context of at least FIG. 3.

In some examples, generating a second portion of printed output that completes the print job and that includes the first portion of printed output using the second printing device can include: while printing the second portion, determining that an erroneous page of the first portion of printed output has jammed the second printing device; determining whether the erroneous page is eligible for printing on the second printing device; and after determining that the erroneous page is eligible for printing on the second printing device: determining whether the second printing device is no longer jammed, and after determining that the second printing device is no longer jammed, printing the erroneous page on the second printing device, such as discussed above in the context of at least FIGS. 4 and 7.

In some examples, generating the second portion of printed output that completes the print job and that includes the first portion of printed output using the second printing device can include: while printing the second portion, determining that an erroneous page of the first portion of printed output has jammed the second printing device, determining whether the erroneous page is eligible for printing on the second printing device, and after determining that the erroneous page is not eligible for printing on the second printing device, reprinting the erroneous page on the first printing device, such as discussed above in the context of at least FIG. 4.

In some examples, method 800 can further include: after reprinting the erroneous page on the first printing device, providing the reprinted page to the second printing device; determining whether the second printing device is no longer jammed; and after determining that the second printing device is no longer jammed, continuing to generate the second portion of printed output using the second printing device, such as discussed above in the context of at least FIG. 4.

In some examples, the second printing device can have a control panel, and method 800 can further include: after determining that an erroneous page of the first portion of printed output has jammed the second printing device, displaying an indication that the erroneous page is being reprinted on the first printing device using the control panel of the second printing device, such as discussed above in the context of at least FIG. 4.

In some examples, method 800 can further include: after the reprinted page is provided to the second printing device, receiving an input from the control panel of the second printing device that indicates the reprinted page has been provided to the second printing device; and after receiving the input from the control panel of the second printing device, continuing to generate the second portion of printed output using the second printing device, such as discussed above in the context of at least FIG. 4.

In some examples, the first page can be associated with a first region of pixels that is eligible for printing on at least the first printing device and with a second region of pixels that is eligible for printing on at least the second printing device; where the first region of pixels does not overlap the second region of pixels; generating the first portion of printed output that partially completes the print job using the first printing device can include printing at least the first region of pixels of the first page on the first output page using the first printing device; and generating the second portion of printed output that completes the print job and that includes the first portion of printed output using the second printing device can include printing at least the second region of pixels on the first output page using the second printing device, such as discussed above in the context of at least FIG. 3.

In some examples, the first region of pixels can include a first scanline of pixels; the second region of pixels can include a second scanline of pixels; printing at least the first region of pixels of the first page on the first output page using the first printing device can include printing at least the first scanline of pixels on the first output page using the first printing device; and printing at least the second region of pixels on the first output page using the second printing device can include printing at least the second scanline of pixels on the first output page using the second printing device, such as discussed above in the context of at least FIG. 3.

The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1. A method, comprising:
receiving, at a first printing device, a request for printing a print job having one or more pages, the print job having a first portion that is eligible for printing on at least the first printing device and that is associated with a first set of printing characteristics and a second portion that is eligible for printing on at least a second printing device and that is associated with a second set of printing characteristics, wherein the second set of printing characteristics differ from the first set of printing characteristics, and wherein at least a first page of the one or more pages is in both the first portion of the print job and the second portion of the print job;
generating a first portion of printed output that partially completes the print job using the first printing device, wherein the first portion of printed output comprises a first output page that corresponds to the first page of the one or more pages, and wherein the first output page is printed by the first printing device according to the first set of printing characteristics;
providing the first portion of printed output to the second printing device; and
generating a second portion of printed output that completes the print job and that includes the first portion of printed output using the second printing device, wherein the second portion of printed output comprises the first output page having been further printed by the second printing device according to the second set of printing characteristics,
wherein generating the second portion of printed output that completes the print job and that includes the first portion of printed output using the second printing device comprises:
while printing the second portion, determining that an erroneous page of the first portion of printed output has jammed the second printing device;
determining whether the erroneous page is eligible for printing on the second printing device; and
prior to completing the print job, printing the erroneous page.

2. The method of claim 1, wherein the first set of printing characteristics is associated with a first type of printing that is either a color type of printing or a monochrome type of printing;
wherein the second set of printing characteristics is associated with a second type of printing; wherein the second type of printing is the color type of printing when the first type of printing is the monochrome type of printing; wherein the second type of printing is the monochrome type of printing when the first type of printing is the color type of printing;
wherein generating the first portion of printed output that partially completes the print job using the first printing device comprises generating the first portion of printed output using the first printing device to perform the first type of printing; and
wherein generating the second portion of printed output that completes the print job and that includes the first portion of printed output using the second printing device comprises generating the second portion using the second printing device to perform the second type of printing.

3. The method of claim 1, wherein the one or more pages comprises a second page that is not part of the first portion and that is part of the second portion;
wherein generating the first portion of printed output that partially completes the print job using the first printing device comprises printing a blank page representing the second page as part of the first portion of printed output; and
wherein generating the second portion of printed output that includes the first portion of printed output using the second printing device comprises printing the second page on the blank page representing the second page as part of the second portion of printed output.

4. The method of claim 1, wherein the one or more pages comprises a second page that is not part of the first portion and that is part of the second portion;
wherein generating the first portion of printed output that partially completes the print job using the first printing device comprises refraining from printing the second page as part of the first portion of printed output; and
wherein generating the second portion of printed output that includes the first portion of printed output using the second printing device comprises:
printing a first sub-portion of the second portion that includes all of the one or more pages that are to be printed before the second page,
printing the second page on a page that is not part of the first portion of printed output, and
printing a second sub-portion of the second portion that includes all of the one or more pages that are to be printed after the second page.

5. The method of claim 1, further comprising:
after determining that the erroneous page is eligible for printing on the second printing device:
determining whether the second printing device is no longer jammed, and
after determining that the second printing device is no longer jammed, printing the erroneous page on the second printing device.

6. The method of claim 1, further comprising:
after determining that the erroneous page is not eligible for printing on the second printing device, reprinting the erroneous page on the first printing device.

7. The method of claim 6, further comprising:
after reprinting the erroneous page on the first printing device, providing the reprinted page to the second printing device;
determining whether the second printing device is no longer jammed; and
after determining that the second printing device is no longer jammed, continuing to generate the second portion of printed output using the second printing device.

8. The method of claim 7, wherein the second printing device has a control panel, and wherein the method further comprises:
after determining that an erroneous page of the first portion of printed output has jammed the second printing device, displaying an indication that the erroneous page is being reprinted on the first printing device using the control panel of the second printing device; and
after continuing to generate the second portion of printed output using the second printing device, determining whether there are additional one or more pages for printing in the print job.

9. The method of claim 8, further comprising:
after the reprinted page is provided to the second printing device, receiving an input from the control panel of the second printing device that indicates the reprinted page has been provided to the second printing device; and
after receiving the input from the control panel of the second printing device, continuing to generate the second portion of printed output using the second printing device.

10. The method of claim 1, wherein the first page is associated with a first region of pixels that is eligible for printing on at least the first printing device and with a second region of pixels that is eligible for printing on at least the second printing device;
wherein the first region of pixels does not overlap the second region of pixels;
wherein generating the first portion of printed output that partially completes the print job using the first printing device comprises printing at least the first region of pixels of the first page on the first output page using the first printing device; and
wherein generating the second portion of printed output that completes the print job and that includes the first portion of printed output using the second printing device comprises printing at least the second region of pixels on the first output page using the second printing device.

11. The method of claim 10, wherein the first region of pixels comprises a first scanline of pixels;
wherein the second region of pixels comprises a second scanline of pixels;
wherein printing at least the first region of pixels of the first page on the first output page using the first printing device comprises printing at least the first scanline of pixels on the first output page using the first printing device; and
wherein printing at least the second region of pixels on the first output page using the second printing device comprises printing at least the second scanline of pixels on the first output page using the second printing device.

12. A system, comprising:
a first printing device having one or more first processors and first data storage that includes first computer-readable instructions; and
a second printing device having one or more second processors and second data storage that includes second computer-readable instructions,
wherein the first computer-readable instructions are executed by the one or more first processors to cause the first printing device to perform first functions that include:
receiving a request for printing a print job having one or more pages, the print job having a first portion that is eligible for printing on at least the first printing device and that is associated with a first set of printing characteristics and a second portion that is eligible for printing on at least a second printing device and that is associated with a second set of printing characteristics, wherein the second set of printing characteristics differ from the first set of printing characteristics, and wherein at least a first page of the one or more pages is in both the first portion of the print job and the second portion of the print job, and
generating a first portion of printed output that partially completes the print job, wherein the first portion of printed output comprises a first output page that corresponds to the first page of the one or more pages, and wherein the first output page is printed by the first printing device according to the first set of printing characteristics; and
wherein after the first portion of printed output is provided to the second printing device, the second computer-readable instructions are executed by the one or more second processors to cause the second printing device to perform second functions that include:
generating a second portion of printed output that completes the print job and that includes the first portion of printed output, wherein the second portion of printed output comprises the first output page having been further printed by the second printing device according to the second set of printing characteristics,
wherein generating the second portion of printed output that completes the print job and that includes the first portion of printed output using the second printing device comprises:
while printing the second portion, determining that an erroneous page of the first portion of printed output has jammed the second printing device;
determining whether the erroneous page is eligible for printing on the second printing device; and
prior to completing the print job, printing the erroneous page.

13. The system of claim 12, wherein the first set of printing characteristics is associated with a first type of printing that is either a color type of printing or a monochrome type of printing;
wherein the second set of printing characteristics is associated with a second type of printing; wherein the second type of printing is the color type of printing when the first type of printing is the monochrome type of printing; wherein the second type of printing is the monochrome type of printing when the first type of printing is the color type of printing;
wherein generating the first portion of printed output that partially completes the print job using the first printing device comprises generating the first portion of printed output using the first printing device to perform the first type of printing; and
wherein generating the second portion of printed output that completes the print job and that includes the first portion of printed output using the second printing device comprises generating the second portion using the second printing device to perform the second type of printing.

14. The system of claim 12, wherein the one or more pages comprises a second page that is not part of the first portion and that is part of the second portion;
wherein generating the first portion of printed output that partially completes the print job comprises printing a blank page representing the second page as part of the first portion of printed output; and
wherein generating the second portion of printed output that includes the first portion of printed output comprises printing the second page on the blank page representing the second page as part of the second portion of printed output.

15. The system of claim 12, wherein the one or more pages comprises a second page that is not part of the first portion and that is part of the second portion;
wherein generating the first portion of printed output that partially completes the print job comprises refraining from printing the second page as part of the first portion of printed output; and
wherein generating the second portion of printed output that includes the first portion of printed output comprises:
printing a first sub-portion of the second portion that includes all of the one or more pages that are to be printed before the second page;
printing the second page on a page that is not part of the first portion of printed output; and
printing a second sub-portion of the second portion that includes all of the one or more pages that are to be printed after the second page.

16. The system of claim 12, wherein the second computer-readable instructions are executed by the one or more second processors to cause the second printing device to perform second functions that further include:
after determining that the erroneous page is eligible for printing on the second printing device:
determining whether the second printing device is no longer jammed, and
after determining that the second printing device is no longer jammed, printing the erroneous page on the second printing device.

17. The system of claim 12, wherein the second computer-readable instructions are executed by the one or more second processors to cause the second printing device to perform second functions that further include:
after determining that the erroneous page is not eligible for printing on the second printing device, reprinting the erroneous page on the first printing device.

18. The system of claim 17, wherein the second printing device has a control panel, and wherein the second functions further comprise:
after determining that an erroneous page of the first portion of printed output has jammed the second printing device, displaying an indication that the erroneous page is being reprinted on the first printing device using the control panel of the second printing device; and
after continuing to generate the second portion of printed output using the second printing device, determining whether there are additional one or more pages for printing in the print job.

19. The system of claim 12, wherein the first page is associated with a first region of pixels that is eligible for printing on at least the first printing device and with a second region of pixels that is eligible for printing on at least the second printing device;
wherein the first region of pixels does not overlap the second region of pixels;
wherein generating the first portion of printed output that partially completes the print job using the first printing device comprises printing at least the first region of pixels of the first page on the first output page using the first printing device; and
wherein generating the second portion of printed output that completes the print job and that includes the first portion of printed output using the second printing device comprises printing at least the second region of pixels on the first output page using the second printing device.

20. The system of claim 19, wherein the first region of pixels comprises a first scanline of pixels;
wherein the second region of pixels comprises a second scanline of pixels;
wherein printing at least the first region of pixels of the first page on the first output page using the first printing device comprises printing at least the first scanline of pixels on the first output page using the first printing device; and
wherein printing at least the second region of pixels on the first output page using the second printing device comprises printing at least the second scanline of pixels on the first output page using the second printing device.
